(19) United States
(12) Patent Application Publication
(10) Pub. No.: US 2010/0079799 A1
(43) Pub. Date: Apr. 1, 2010

(54) Media Processing Device, Control Method for a Media Processing Device, and a Control Program for a Media Processing Device

(75) Inventors: Kazuya Toshima, Nagano-ken (JP); Norio Tsuchiya, Nagano-ken (JP); Akihiko Tsuchiya, Nagano-ken (JP)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(73) Assignee: Seiko Epson Corporation, Tokyo (JP)

(21) Appl. No.: 12/562,549

(22) Filed: Sep. 18, 2009

(30) Foreign Application Priority Data
Sep. 30, 2008 (JP) 2008-255400
Sep. 30, 2008 (JP) 2008-255409
Sep. 30, 2008 (JP) 2008-255521
May 13, 2009 (JP) 2009-116195

(51) Int. Cl. G06F 3/12

(52) U.S. Cl. 358/1.15

(57) ABSTRACT

A media processing device and a control method therefor separate the control unit that detects state changes and the control unit that controls executing processes according to a state change. The media processing device has a label printer 11 that prints to the label side of media, media stackers 21 and 22 that store media, a media transportation mechanism 31 that transports media to the label printer 11 and the media stackers 21 and 22, an automatic loader control unit 102 that controls the label printer 11 and the media transportation mechanism 31, and a main control unit 101 that sends control commands to the automatic loader control unit. The control method involves the automatic loader control unit 102 converting a state change in the label printer 11 or the media transportation mechanism 31 to a status signal and sending the status signal to the main control unit 101, and the main control unit 101 interpreting the received status report and executing a process corresponding to the result.

### CROSS-REFERENCE TO RELATED APPLICATIONS

Japanese Patent application No(s). 2008-255521, 2008-255400, 2008-255409, and 2009-116195 are hereby incorporated by reference in their entirety.

### BACKGROUND

1. Field of Invention

The present invention relates to a media processing device, and a control method and control program therefor, and more particularly to the control of display messages or control of the illumination pattern of plural LEDs (light-emitting diodes) or other display indicators simultaneously in a media processing device having a display unit for presenting various messages on an operating panel of the device.

2. Description of Related Art

Media processing devices that write data and print labels on large numbers of media (information recording media) such as CDs (Compact Discs) and DVDs (digital versatile discs) media are known from the literature. Such media processing devices typically have a media stacker (media storage unit) for storing disc-shaped media in a stack, a media drive for writing data to the media, and a label printer for printing on the label side of the media, and a media transportation mechanism for holding and conveying the media to and from these media processing units (the media drive and label printer).

Media processing devices such as these have an operating panel and indicate switch input and device states using indicating lamps. In the media processing device of Japanese Unexamined Patent Appl. Pub. JP-A-2008-103032, for example, device states are indicated using only LEDs. The illumination pattern of the LEDs is determined and controlled by firmware in the media processing device.

With the media processing device of JP-A-2008-103032, controlling the LEDs used for state indication is done by controlling each LED individually.

This LED control method according to the related art is described next with reference to FIG. 19, which shows the control sequence when this control method is used to change the lighting pattern and the state indicated by three LEDs on a media processing device.

As shown in FIG. 19, the control unit of the media processing device issues a control command to each of three (3) LEDs sequentially to control their operation, e.g., to change the lighting pattern of the three LEDs: an Error LED, which is an error indicator indicating an operational error, a Power LED used as a power indicator, and a Busy LED used as a busy indicator.

With continued reference to FIG. 19, the control unit of the media processing device first generates a control command for the Power LED (step S101) and then sends this control command to the Power LED (step S102) to, for example, change its illumination state from “off” to “on” (step S103). The control unit then generates a control command for the Busy LED (step S104) and sends the control command to the Busy LED (step S105) to, for example, change its illumination state from “off” to “blinking” (step S106). The control unit then generates a control command for the Error LED (step S107) and sends the control command to the Error LED (step S108) to, for example, change its illumination state from “off” to “blinking” (step S109).

Companies and other organizations, however, generally have a local area network (LAN) installed with a central server and multiple client computers, printers, and other output devices connected to the LAN. Users of the network use the client computers to create and edit different types of documents, graphics, and other content. The resulting data is stored and managed using internal storage local to the client computer, or written to a removable data storage medium such as a CD or a DVD type media.

The media processing device of Japanese Unexamined Patent Appl. Pub. JP-A-media detection mechanism 2000-260172 can write the resulting data to such removable media when connected to the network. The user can easily remove the recorded media from the stacker by opening a door to the media processing device. As a result, if the data recorded is a highly confidential information asset, the information asset recorded to the media can be easily acquired. Discs to which highly confidential information assets are recorded require strict control, and must be administered so that they cannot be easily removed.

On the other hand, because such media processing devices are commonly used to process confidential data, measures are required to prevent damaging or deleting data that is written to a recording medium or data that is printed on the recording medium, and to prevent damage to or loss of the media that was written or printed. More specifically, data security measures that include the media used in the media processing device are needed.

It is therefore necessary to detect the status of the media processing device and to accurately inform the user or the connected computer. In addition, data from the computer must be received without error or loss. If, for example, the power supply switch is turned off while writing or printing to the media or while transporting the media, processing should not stop and should continue until the processes being executed are completed.

In addition, if the media processing device has a cover, the cover must be locked so that the media can only be removed by authorized persons.

Yet further, when a plurality of LEDs or other indicators are used as display devices and particular states are indicated by causing the LEDs to light in particular combinations or blinking patterns, the operator may erroneously read a different status indication, if the timing of the blinking indicating lamps is not synchronized correctly.

### SUMMARY OF INVENTION

According to one aspect of the invention, a media processing device is provided that can handle confidential data, prevent damage to or loss of data written to media or printed on media, and prevent damage to or loss of the written or printed media, and protects (secures) data, including the media handled by the media processing device. Other aspects of the invention relate to a control method for the media processing device, and to a control program for the media processing device.

Regarding the display LEDs, if a unique meaning is assigned to each of a plurality of particular combinations of illumination patterns produced by plural LEDs, various states of the media processing device can be displayed using few LEDs. However, to differentiate the display states of the individual LEDs, the illumination pattern of the plural LEDs preferably changes simultaneously.

Because the media processing device according to the related art individually controls each of the LEDs in order to control the status display state of the LEDs used as status indicators, control commands must be sent sequentially to the LEDs, with each LED receiving a control command in turn. As a result, if the response to any of the control commands is poor, it can be difficult to differentiate state changes of the individual, affected LEDs, which in turn shifts the timing at which the illumination pattern of the LED combination changes, and makes it difficult to sense the pattern change.

Synchronizing the blinking of plural LEDs can also be difficult with the media processing device according to the related art described above.

To solve this problem embodiments of the present invention can cause the illumination state of a plurality of LEDs to change simultaneously, and can facilitate synchronizing the timing at which the LEDs blink, when a unique meaning is given to each of the illumination patterns, each produced by different state combinations of plural LEDs.

A security system that, for example, provides a lock in the front access door, verifies the user by means of an ID and password, for example, when removing media, and opens the lock only when the user is verified is also conceivable as a media management method. Security systems that identify and authenticate users by means of an ID and password normally operate when power is supplied, but the security system disengages when the power is turned off. For example, when the power supply is turned off and on using a physical hardware switch, the security system disengages unconditionally when the power supply switch is off. The power supply switch can therefore be turned off while highly confidential media remains inside the media processing device. The complete media can therefore be removed without user identification and authentication. If there are plural users, the power may also be turned off even though the media processing device is being used by someone else.

Solving this problem is yet another object of the present invention. Embodiments of the present invention can thus prevent a security system from disengaging when completed media to which confidential data has been written remains in the media processing device, and can also protect data assets during processing (including writing and transportation).

According to a first aspect of the invention, a control method for operating a media processing device is provided. The device has a printer that prints at least on the label side of media, a media storage unit that stores the media, a media transportation mechanism that transports the media, a loader control unit (e.g., an automatic loader control unit) that controls the printer and the media transportation mechanism, and a main control unit that sends control commands to and controls the loader control unit. The control method comprises the loader control unit sending information relating to a state change to the main control unit based on a state change in at least one of the printer or the media transportation mechanism; and the main control unit evaluating the received information related to the state change and executing a process based on the result of the evaluation.

In at least one embodiment of the control method, the media processing device also has an operating panel including an input unit and a display unit (e.g., a message display unit) that displays a message, the loader control unit controlling the display unit in addition to controlling the printer and the media transportation mechanism. The process executed by the main control unit based on the evaluation result is a process of generating and sending to the loader control unit a display unit control command (e.g., a message display unit control command) including the message. The control method further comprises the loader control unit controlling the display unit and displaying the message according to the received display unit control command.

Preferably, in the sending step, the loader control unit sends information related to the state change to the main control unit when an input signal is received from the input unit.

In at least one embodiment of the control method, the sending step involves the loader control unit sending information related to the detected state change to the main control unit when a state change sensed by a sensor disposed to the media processing device is detected.

In at least one embodiment of the control method, the media processing device also has a lamp unit (e.g., an indicating lamp unit) including a plurality of lamps; and the loader control unit controls the lamp unit in addition to controlling the printer and the media transportation mechanism. The process executed by the main control unit based on the evaluation result is a process of generating and sending to the loader control unit a lamp control command (e.g., a simultaneous indicating lamp control command) that simultaneously controls the plurality of lamps. The control method further comprises the loader control unit receiving the lamp control command sent from the main control unit, simultaneously controlling the plurality of lamps specified by the lamp control command, and simultaneously changing the illumination pattern of the lamps.

In another aspect of the control method, the media processing device also has a power supply, and a power supply switch, for controlling the power supply, connected to the loader control unit, where the state change is a change in the input state of the power supply switch, and the state change evaluation determines whether or not power supply switch input is off, and the process based on the result of the evaluation is a process of determining if a specified process is executing when the evaluation result is that the power supply switch is off. The control method also has an additional step of executing a process turning the power supply off at least when it is determined that the specified process is not executing.

Further preferably, in a control method for a media processing device according to another aspect of the invention, the media processing device also has a discharge unit to which the media are discharged, where the specified process is a process of transporting the media by the media transportation mechanism to the discharge unit. The control method also has a step of the main control unit executing the process of turning the power supply off after the media transportation process ends, when it is determined that the media transportation process is executing.

Yet further preferably, in a control method for a media processing device according to another aspect of the invention, the media processing device is communicably connected to a computer, and the specified process is receiving data from the computer. The control method also has a step of the main control unit executing the process of turning the power supply off after the data reception process ends, when it is determined that data is being received.

Another aspect of the invention is a tangible medium readable by a media processing device, the tangible medium containing a control program for causing the loader control unit and the main control unit to execute the steps of the media processing device control method described above.

Another aspect of the invention is a media processing device comprising a printer that prints at least on the label side of media; a media storage unit that stores the media; a media transportation mechanism that transports the media; a loader control unit (e.g., an automatic loader control unit) that controls the printer and the media transportation mechanism; and a main control unit that sends control commands to and controls the loader control unit. The loader control unit includes an automatic status back transmission unit that sends to the main control unit information relating to a state change in at least the printer or the media transportation mechanism. The main control unit includes an automatic status back evaluation unit that evaluates the received information related to the state change and executes a process based on the result of the evaluation.

By configuring the media processing device with a loader control unit (e.g., an automatic loader control unit) for controlling mechanisms such as the printer, and a main control unit providing overall control of the media processing device, mechanical changes can be accommodated by changing only the loader control unit without the need to change the main control unit.

A media processing device according to another aspect of the invention further comprises an operating panel including a display unit that displays a message and an input unit. The loader control unit controls the display unit in addition to controlling the printer and the media transportation mechanism. The main control unit also has a control command generating unit that generates and sends to the loader control unit a display unit control command including a message based on the result of the evaluation by the automatic status back evaluation unit. The loader control unit also having a control command conversion unit for displaying the message on the display unit based on the received display unit control command.

A media processing device according to another aspect of the invention further comprises an indicating lamp unit having a plurality of indicating lamps. The loader control unit controls the indicating lamp unit in addition to controlling the printer and the media transportation mechanism. The main control unit also has a control command generating unit that generates and sends to the loader control unit a simultaneous indicating lamp control command that simultaneously changes the illumination pattern of at least two of the indicating lamps specified from among the plurality of indicating lamps, and the loader control unit also has a control command conversion unit that converts the received simultaneous indicating lamp control command to a control signal that simultaneously changes the illumination pattern of the specified plural indicating lamps.

A media processing device according to another aspect of the invention further comprises a power supply, and a power supply switch, for controlling the power supply, connected to the loader control unit. The state change is a change in the input state of the power supply switch, the state change evaluation determines whether or not power supply switch input is off, the process based on the result of the evaluation is a process of determining if a specified process is executing when the evaluation result is that the power supply switch is off, and the main control unit executes a process turning the power supply off at least when it is determined that the specified process is not executing.

Further preferably in a media processing device according to another aspect of the invention, the main control unit executes a process of turning the power supply off after the specified process ends, if the evaluation result is that the power supply is off and the specified process is executing at that time.

Yet further preferably, a media processing device according to another aspect of the invention further comprises a discharge unit to which the media are discharged. The specified process is a media transportation process of the transportation unit, and the main control unit executes the process of turning the power supply off after the media transportation process ends.

Further preferably, the media processing device according to another aspect of the invention is communicably connected to a computer, the specified process is receiving data from the computer, and the main control unit executes the process of turning the power supply off after the data reception process ends.

Yet further preferably, the media processing device according to another aspect of the invention also includes a cover for removing and loading the media, and an electronic lock for locking and unlocking the cover, and the main control unit controls and causes the electronic lock to lock or unlock the cover.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is an external oblique view of a media processing device, in accordance with embodiments of the invention, with the access covers closed.

FIG. 2 is an external oblique view of the media processing device with the access covers open.

FIG. 3 is an oblique view from the top front side of the media processing device with the case removed.

FIG. 4 is an oblique view of a label printer unit disposed inside the media processing device.

FIG. 5 is a block diagram showing the configuration of main parts of a control system of the media processing device according to a preferred embodiment of the invention.

FIG. 6 is an enlarged view of an operating panel of the media processing device according to a preferred embodiment of the invention.

FIG. 7 is a sequence diagram describing a display control method of a media processing device according to a preferred embodiment of the invention.

FIG. 8 is a sequence diagram describing a display control method of an LCD (message display unit) in a media processing device according to a first embodiment of the invention.

FIG. 9 is a schematic illustration of a specific example of guiding user operations on the LCD (message display unit) of the media processing device according to the first embodiment of the invention.

FIG. 10 is an enlarged view of an indicating lamp unit of the media processing device according to a second embodiment of the invention.

FIG. 11 is a block diagram showing the configuration of main parts of the control system of the media processing device according to a second embodiment of the invention.

FIG. 12 is a diagram showing the simultaneous control sequence of three LEDs by means of the simultaneous indicating lamp control command in a media processing device according to the second embodiment of the invention.

FIG. 13 is a diagram showing the simultaneous control sequence of two LEDs by means of the simultaneous indicating lamp control command in a media processing device according to the second embodiment of the invention.

FIG. 14 is a diagram showing the simultaneous control sequence of one LED by means of the simultaneous indicating lamp control command in a media processing device according to the second embodiment of the invention.

FIG. 15 is a block diagram showing the internal processes of the media processing device according to a third embodiment of the invention.

FIG. 16 shows an example of a job management table in a media processing device according to the third embodiment of the invention.

FIG. 17 shows the job management table after being updated in a media processing device according to the third embodiment of the invention.

FIG. 18 is a flow chart describing a control method of a media processing device according to the third embodiment of the invention.

FIG. 19 shows the control sequence of a control method according to the related art when changing the illumination pattern of three LEDs of a media processing device.

### DESCRIPTION OF THE PREFERRED EMBODIMENTS

Preferred embodiments of a media processing device, a control method for a media processing device, and a control program for the same according to the present invention are described below with reference to the accompanying figures.

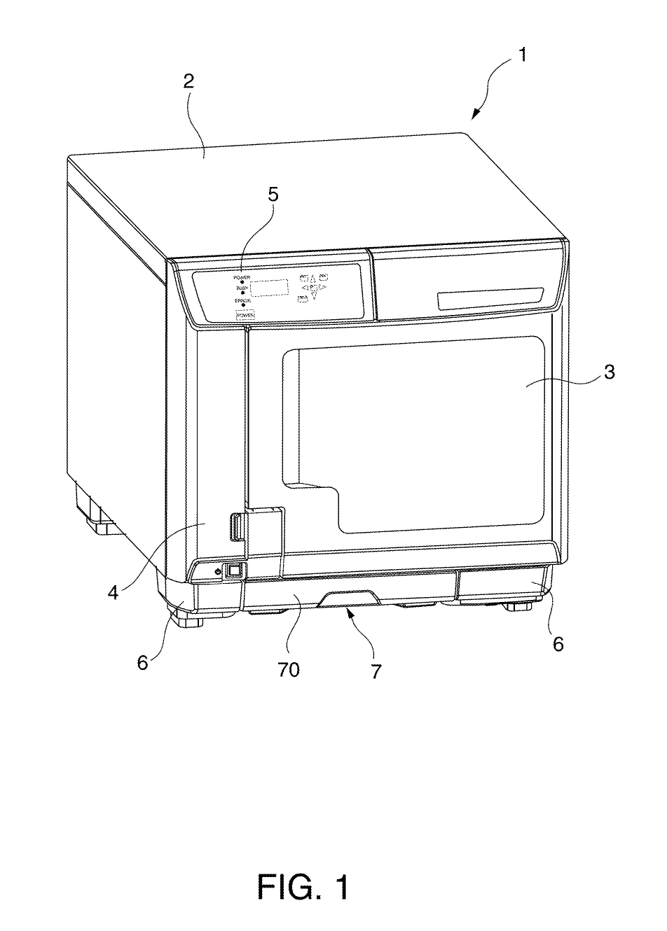

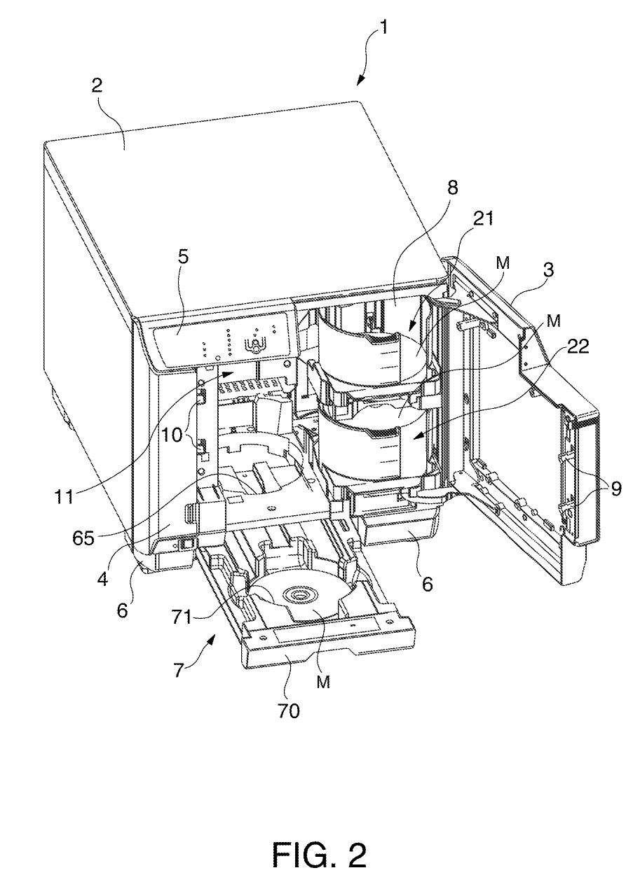

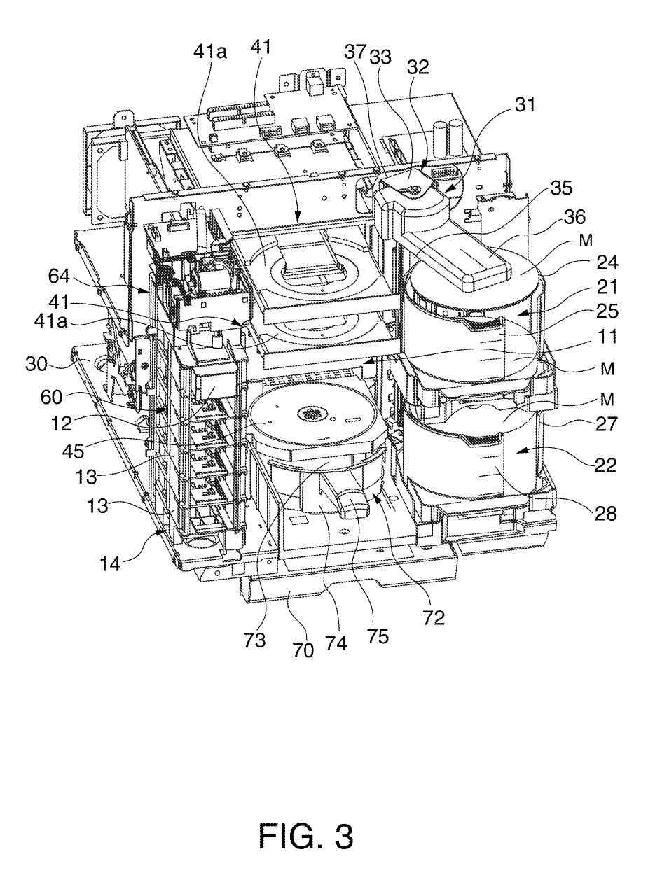

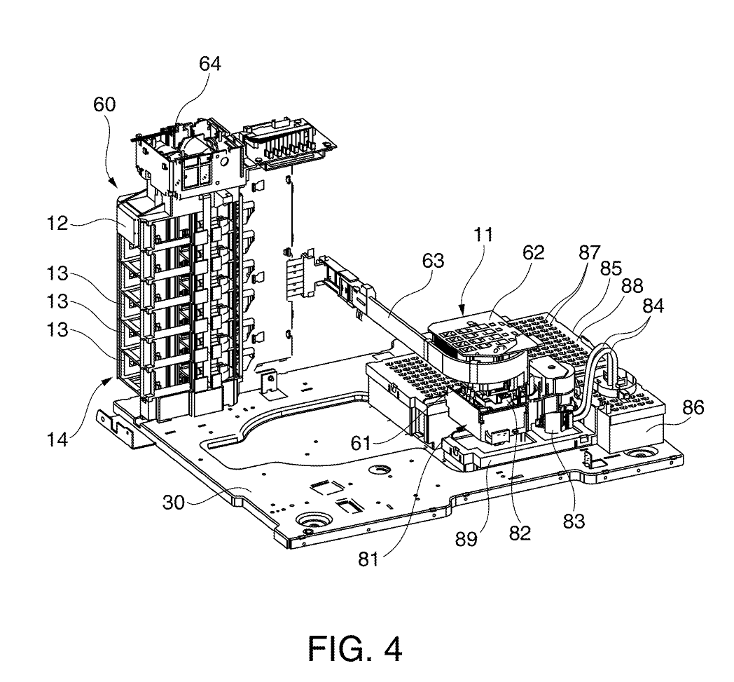

FIG. 1 is an external oblique view of a media processing device when parts thereof are closed, FIG. 2 is an external oblique view of the media processing device when such parts are open, FIG. 3 is an oblique view from above the front of the media processing device with the case thereof removed, and FIG. 4 is an oblique view showing the label printer unit disposed in the media processing device.

The general configuration of a media processing device according to this embodiment of the invention is described first.

As shown in FIG. 1, the media processing device 1 is a device that writes data to, and prints on the label side of, disc-shaped media such as CDs and DVDs, and has a basically box-shaped case 2. Doors 3 and 4 that open and close are attached at the front of the case 2. An operating panel 5 is disposed at the top left part of the case 2, and support legs 6 project down from the bottom of the case 2 on both right and left sides. A drawer mechanism 7 is disposed between the right and left legs 6. Disposed to the operating panel 5 are LED (light-emitting diode) indicating lamps, a liquid crystal display (LCD) as a message display unit for displaying messages, and input keys and buttons for input operations.

As shown in FIG. 2, the access door 3 on the right side when seen from the front opens and closes for access to an open area 8 at the front of the media processing device 1, and is the door that opens and closes for loading unused (blank) media M through the open area 8 and for removing finished media M from the open area 8.

The access door 4 on the front left side opens and closes for replacing the ink cartridges 12 of the label printer 11 shown in FIG. 3. When the door 4 is open, a cartridge carrier unit 14 with a plurality of cartridge holders 13 arrayed in a vertical stack is exposed.

A cover-side hook 9 is disposed at the end part of the access door 3 and a matching case-side catch 10 is formed at a position corresponding to the cover-side hook 9 so that the cover-side hook 9 and case-side catch 10 can engage each other. A plunger not shown connected to the case-side catch 10 is disposed inside the case 2 so that energizing the plunger causes the case-side catch 10 to move, rendering an electronic lock that can engage and disengage the cover-side hook 9. This electronic lock can be engaged and disengaged in conjunction with operations involving turning the power on and off.

As shown in FIG. 2 and FIG. 3, a media stacker 21 used as a media storage unit for holding a plurality of unused discs M (such as 50) to which data has not been written, and a media stacker 22 used as a media storage unit for holding a plurality (such as 50) of completed discs M or blank discs M, are disposed one above the other inside the case 2 of the media processing device 1 so that the center axes of the media M stored therein are the same. The blank media stacker 21 and the completed media stacker 22 can be freely installed to and removed from their respective positions.

The top media stacker 21 has a pair of right and left curved side walls 24 and 25. The blank discs M are thus received from the top and can be stored in a substantially coaxial stack. The task of storing or loading blank discs M into the blank media stacker 21 can be done easily by opening the door 3 and pulling the media stacker 21 out.

The bottom media stacker 22 is identically constructed with a pair of right and left curved side walls 27 and 28, thus rendering a media stacker that can receive discs M from the top and can store the media M in a substantially coaxial stack.

As shown in FIG. 3, a media transportation mechanism 31 is located behind the media stackers 21 and 22. The media transportation mechanism 31 has a vertical guide shaft 35 disposed vertically between the main frame 30 and the top plate 33 of the chassis 32. A transportation arm 36 is supported so that it can move up and down and rotate on the vertical guide shaft 35. The transportation arm 36 can move vertically up and down along the vertical guide shaft 35 and can pivot right and left on the vertical guide shaft 35 by means of a drive motor 37.

Two media drives 41 are disposed one above the other at a position behind and beside the two stackers 21 and 22 and the media transportation mechanism 31, and the carriage 62 described below of the label printer 11 is disposed movably below the media drives 41.

Each of the media drives 41 has a media tray 41a, which can move between a data writing position where data is recorded to the discs, and a media transfer position where the media can be loaded and unloaded from the media tray 41a.

The label printer 111 also has a media tray 45 that can move between a printing position for printing a label on the label side of the media M, and a media transfer position where the media can be loaded and unloaded from the media tray 45.

FIG. 3 shows the media trays 41a of the top and bottom media drives 41 pulled out to the media transfer position, and the media tray 45 of the label printer 11 therebelow pulled out to the media transfer position.

The label printer 11 in this embodiment of the invention is an inkjet printer that uses color ink cartridges 12 (for six colors, specifically, black, cyan, magenta, yellow, light cyan, and light magenta) as the ink supply mechanism 60. The ink cartridges 12 are installed from the front to the individual cartridge holders 13 of the cartridge carrier unit 14.

A space enabling the transportation arm 36 of the media transportation mechanism 31 to move up and down is formed between the pair of right and left side walls 24 and 25 of the one media stacker 21 and between the pair of right and left side walls 27 and 28 of the other media stacker 22. A space is also formed between the top and bottom media stackers 21 and 22 so that the transportation arm 36 of the media transportation mechanism 31 can pivot horizontally for positioning directly above the bottom media stacker 22. When both media trays 41a are pushed into the media drives 41, the transportation arm 36 of the media transportation mechanism 31 can be lowered and can access the media tray 45 of the label printer 11 at the media transfer position.

When both media trays 41a are in the data writing position and the media tray 45 for the label printer 11 is at the inside printing position, the transportation arm 36 of the media transportation mechanism 31 can descend below the height of the media tray 45. A guide hole through which a disc M released by the transportation arm 36 after descending to this position passes is located below the media transfer position of the printer media tray 45, and another media stacker can be installed in this guide hole 65.

As shown in FIG. 2 and FIG. 3, the drawer mechanism 7 has a drawer-like tray 70 disposed below the main frame 30 so that the drawer tray 70 can be pulled out from the main frame 30 and opened or slid into the main frame 30 and closed. The drawer tray 70 has a recess in which a media stacker unit 71 can store the media M. When this drawer tray 70 is in the stored (closed) position, the media stacker unit 71 is positioned below the guide hole 65. The center of the media stacker unit 71 is positioned with the center of the media stacker unit 71 coaxial to the center axis of both media trays 41a and the printer media tray 45 in the media transfer position. This media stacker unit 71 accepts media M guided thereinto by the guide hole 65, and stores a relatively small number of media M (such as 5 to 10). The media stacker unit 71 accepts the media M from the top and can store the media M stacked coaxially.

Another media stacker 72 (removable media stacker) that can hold more media M than the media stacker unit 71 can be removably installed in the guide hole 65 and the media stacker unit 71 of the drawer tray 70 in the storage position (see FIG. 3). This media stacker 72 also has two curved side walls 73 and 74, and can thereby receive media M from the top and can store a plurality of media M (such as 50) in a coaxial stack. A gap enabling the transportation arm 36 of the media transportation mechanism 31 to move up and down is also formed between the pair of curved side walls 73 and 74. A handle 75 that is held by the user when installing and removing the media stacker 72 is disposed at the top part of the one side wall 74.

When the media stacker 72 is installed, a blank disc M can be taken from the bottom media stacker 22 and then deposited in the media stacker 72 after writing data and printing by means of the media drive 41 and the label printer 11.

For example, both the top media stacker 21 and the bottom media stacker 22 may each be loaded to the maximum capacity (50 discs+50 discs in this embodiment of the invention) with blank media M. All media M (50) in the bottom media stacker 22 are then sequentially processed and stored in the media stacker 72, and then all media M (50) in the top media stacker 21 are sequentially processed and stored in the emptied bottom media stacker 22. This enables processing the maximum number of media M (50+50) that can be loaded in the top media stacker 21 and the bottom media stacker 22 in a single operation (the “batch processing mode”).

When the media stacker media stacker 72 has been removed, a blank disc M can be removed from the top media stacker 21 or the bottom media stacker 22, the disc can be written and printed by the media drive 41 and label printer 11, and the completed disc can then be stored in the media stacker unit 71 of the drawer tray 70 in the stored (closed) position.

The completed media M can thus be removed from the media stacker unit 71 by pulling the drawer tray 70 out. More specifically, completed media M can be sequentially removed one by one or plural discs at a time while processing other media M continues with the access door 3 remaining closed. This is also referred to herein as the “external discharge mode.”

Blank media M may also be stored in one media stacker 21 or the other media stacker 22, and processed media M may be stored in the other media stacker. More specifically, the blank media M are removed from the one media stacker 21 (or media stacker 22) and then stored in the other media stacker 22 (or media stacker 21) after recording data and printing by means of the media drive 41 and label printer 11.

To remove a completed disc M in this situation, the other media M stacked on top of the completed disc M that is to be removed are moved to another media stacker, and only the completed disc M is moved to the media stacker unit 71. The other media M that were moved to the other stacker are then returned to the original location (security mode).

The media M can thus be appropriately conveyed between the top media stacker 21, the bottom media stacker 22, the media stacker unit 71 (or media stacker 72) in the drawer tray 70, the media trays 41a of the media drives 41, and the printer media tray 45 of the label printer 11 by the transportation arm 36 of the media transportation mechanism 31 moving up and down and pivoting right and left in various combinations.

As shown in FIG. 4, the label printer 11 has a carriage 62 with an inkjet head 61 having nozzles (not shown in the figure) for discharging ink. The carriage 62 moves bidirectionally horizontally (not shown in the figure) along a carriage guide shaft by means of the drive power from a carriage motor.

The label printer 11 has an ink supply mechanism 60 with a cartridge carrier unit 14 in which the ink cartridges 12 are installed. The ink supply mechanism 60 is vertically constructed and is attached vertically to the main frame 30 of the media processing device 1. One end of a flexible ink supply tube 63 is connected to the ink supply mechanism 60, and the other end of the ink supply tube 63 is connected to the carriage 62.

Ink in the ink cartridges 12 loaded in the ink supply mechanism 60 is supplied through the ink supply tube 63 to the carriage 62. The ink is supplied to the inkjet head 61 through a damper unit and back pressure adjustment unit (not shown in the figure) disposed to the carriage 62, and discharged from the ink nozzles (not shown in the figure).

A pressurizing mechanism 64 is disposed with the main part at the top of the ink supply mechanism 60, supplies compressed air to pressurize the inside of the ink cartridge 12 and expels ink from the ink pack in the ink cartridge 12.

A head maintenance mechanism 81 is disposed below the home position (shown in FIG. 4) of the carriage 62.

The head maintenance mechanism 81 has a head cap 82 and a waste ink suction pump 83. The head cap 82 covers the ink nozzles of the inkjet head 61 exposed below the carriage 62 in the home position. The waste ink suction pump 83 vacuums ink discharged into the head cap 82 by the ink charging operation and the head cleaning operation of the inkjet head 61.

Ink that is removed by the waste ink suction pump 83 of the head maintenance mechanism 81 is discharged through another tube 84 into the waste ink absorption tank 85. This waste ink absorption tank 85 is an absorption member not shown that is disposed inside the case 86, and has a cover 88 with numerous ventilation holes 87.

A waste ink catch pan 89 that is a part of the waste ink absorption tank 85 is disposed below the head maintenance mechanism 81 to catch and absorb ink that drips from the head maintenance mechanism 81 with an absorbent material.

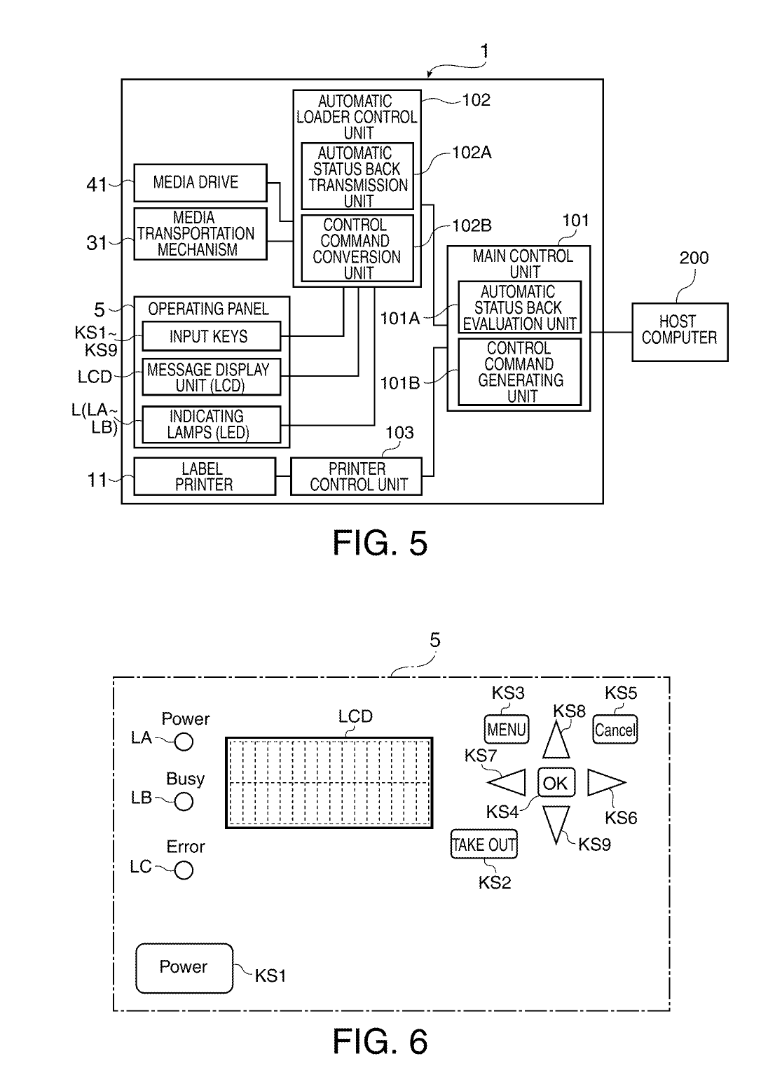

The main parts of the control configuration of a media processing device 1 according to this embodiment of the invention are described next. FIG. 5 is a block diagram showing the main control configuration of the media processing device according to this embodiment of the invention.

As shown in FIG. 5, the media processing device 1 has control units (automatic loader control unit 102 and printer control unit 103) that directly control and drive particular functional units (hardware), and an independent main control unit 101 that sends control commands to and controls these other control units. Because the automatic loader control unit 102 and printer control unit 103 that directly drive and control the other function units (hardware) are provided separately from the main control unit 101, software changes to the host computer that do not accompany changes to the functional (hardware) units can be accommodated by changes to the main control unit 101 alone (by replacing the main control unit 101 or updating the software of the main control unit 101). Note that the automatic loader control unit 102 and the printer control unit 103 have a CPU and memory, and the CPU reads a program stored in memory and executes various processes.

The main control unit 101 also has an automatic status back evaluation unit 101A that makes a decision in response to received ASB (automatic status back) requests. Note that the main control unit 101 sends automatic status back reports automatically to the host computer 200.

The main control unit 101 also has a control command generating unit 101B that sends a control command to the automatic loader control unit 102 based on the decision from the automatic status back evaluation unit 101A. Note that while an automatic status back report is an automatically generated and output status report, it is used herein to mean a specific device state.

The automatic loader control unit 102 also has an automatic status back transmission unit 102A that when a state change in the media processing device 1 is detected converts the detection signal of the detected result to an automatic status back report and sends the ASB report to the main control unit 101. The automatic loader control unit 102 also has a control command conversion unit 102B.

The printer control unit 103 controls the label printer 11 and prints on the label side of the media.

The main control unit 101 is connected to and controls the automatic loader control unit 102 and printer control unit 103 by means of control commands. The main control unit 101 is also connected to a host computer 200 by a communication means, and normally interprets and sends write data, print data, and commands that are sent from the host computer 200 to the automatic loader control unit 102 and label printer 11.

FIG. 6 is an enlarged view of the operating panel of the media processing device according to the third embodiment of the invention. As shown in FIG. 6, the operating panel 5 has three LEDs that are indicating lamps for indicating specific states based on whether the LED is on or off, an LCD as a message display unit, and various buttons and keys as input devices.

These three LEDs are a power supply indicator LA (Power), an error indicator LB (Error) that indicates when an error has occurred, and a busy indicator LC (Busy).

The liquid crystal display is a message display unit that displays menus and messages using letters, numbers, and symbols, for example, presented in a multicolumn, multiline display (a 16 column by 2 line display as denoted by the dot-dash lines in the figure in this example). The letters, numbers, and symbols, for example, displayed in the LCD are stored in nonvolatile memory (such as EEPROM) for use. New letters, numbers, and symbol can also be added as needed.

The input keys in this embodiment include an input key KS1 (POWER) for turning the power on and off; an input key KS2 (EJECT) for removing completed media; an input key KS3 (MENU) for starting and stopping a menu, an input key KS4 (OK) for executing a process, an input key KS5 (CANCEL) for canceling a process, an input key KS6 (right arrow) for moving the cursor or selection on the screen to the right, an input key KS7 (left arrow) for moving left, an input key KS8 (up arrow) for moving up, and an input key KS9 (down arrow) for moving down.

The automatic loader control unit 102 controls the media drive 41 and media transportation mechanism 31 to write data to the medium and convey the medium. The automatic loader control unit 102 also receives input signals from the input keys KS1 to KS9 on the operating panel 5, and controls what is displayed by the LCD (message display unit) and LEDs (indicating lamps) LA to LC.

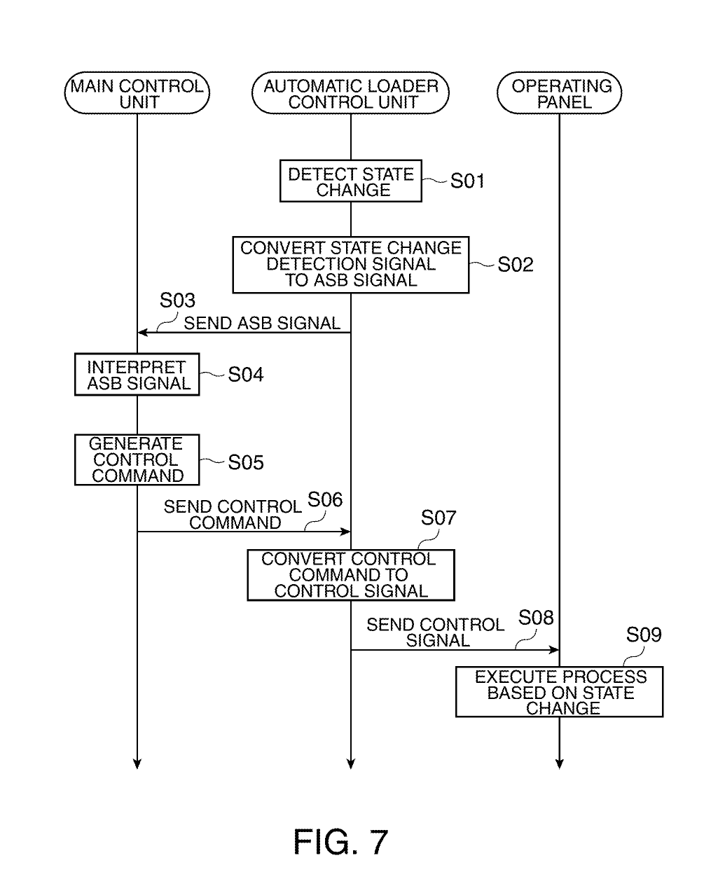

The control method of the media processing device according to this embodiment of the invention is described next with reference to the sequence diagram in FIG. 7.

When a state change, such as opening the lock, media dropping, or the drawer tray opening, is detected in the media processing device 1 (step S01), the automatic status back transmission unit 102A of the automatic loader control unit 102 converts the state change detection signal to an ASB signal (step S02) and sends the ASB signal to the main control unit 101 (step S03).

When the ASB signal is received, the automatic status back evaluation unit 101A of the main control unit 101 evaluates the content (step S04) and executes a process according to the result (that is, what detected state change was reported).

Based on this result, a process corresponding to the type of state change in the media processing device 1 is executed using the LCD (message display unit), LEDs (indicating lamps), buzzer, or internal lighting, for example. More specifically, the control command generating unit 101B generates a control command based on the result (step S05) and sends the control command to the automatic loader control unit 102 (step S06).

The control command conversion unit 102B of the automatic loader control unit 102 then converts the received control command to a control signal (step S07).

The automatic loader control unit 102 then sends the converted control signal to the operating panel 5 (step S08). The LCD (message display unit) or LEDs (indicating lamps) are then controlled in accordance with the control signal to execute a process based on the type of state change (step S09). More specifically, the display content of the LCD (message display unit) is changed, or the illumination pattern of the LEDs (indicating lamps) is changed, or a buzzer is sounded, or internal lighting is turned on/off, for example.

It should be noted that processes may also be executed according to the type of state change in situations such as follow.

A power supply switch for turning the power to the media processing device 1 on and off may be connected to the automatic loader control unit 102 with the main control unit 101 controlling the on/off state of the power supply to the media processing device 1. In this case, when a state change in which the power supply switch is turned off is detected in the automatic loader control unit 102, the state change is sent as an ASB signal to the main control unit 101. If the main control unit 101 receives an ASB signal denoting a state change in which the power supply switch turned off from the automatic loader control unit 102 while printing is in progress, data is being written, or the media is being transported, the main control unit 101 waits until the executing process ends and executes the process turning the power off after all other executing processes have ended.

More specifically, if the power supply switch is connected to the automatic loader control unit and the power supply is connected to the main control unit, the power turns off after media processing ends even if a signal turning the power on/off is input while media is being processed.

### Embodiment 1

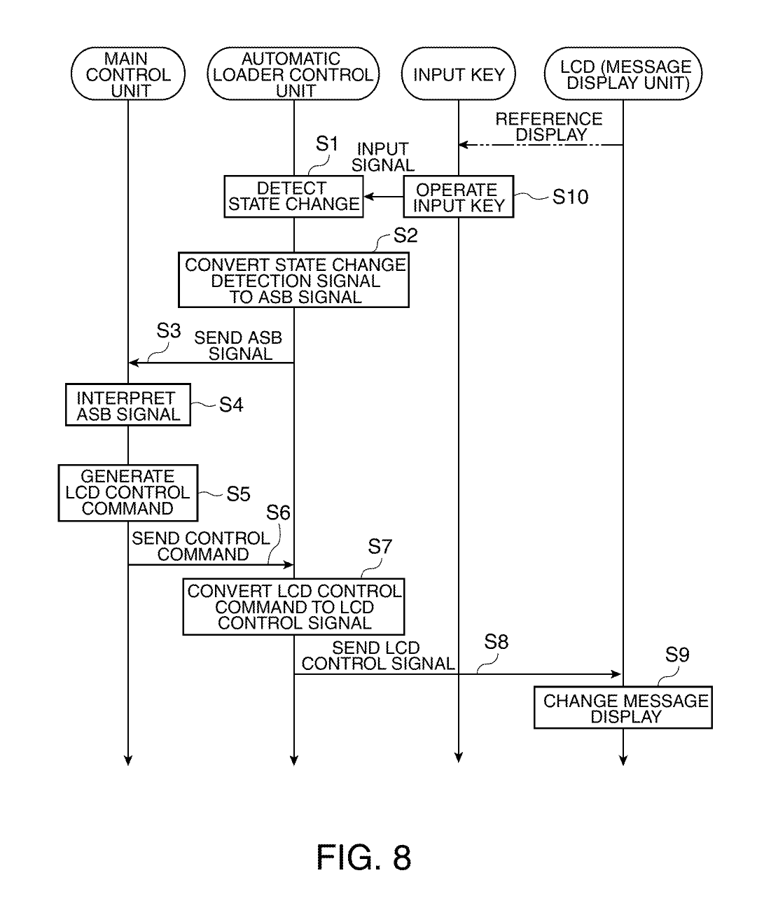

A media processing device and a control method for a media processing device according to a first embodiment of the invention are described next in detail with reference to the sequence diagram shown in FIG. 8.

This first embodiment sends a message display unit control command (LCD control command) to the message display unit (LCD) of the operating panel 5. This message display unit control command (LCD control command) is a control command that changes the display content of the message display unit (LCD).

Referring to menus or other content displayed on the LCD, the user operates the appropriate input keys KS1 to KS9 on the operating panel 5 (step S10). An input signal corresponding to the operated input key is thus sent to the automatic loader control unit 102, and the automatic loader control unit 102 detects the input signal as a state change (step S1). The automatic status back transmission unit 102A of the automatic loader control unit 102 converts this input signal to an ASB (automatic status back) signal (step S2) and sends the ASB signal to the main control unit 101 (step S3).

When this signal is received, the automatic status back evaluation unit 101A of the main control unit 101 evaluates the ASB signal content (step S4), the control command generating unit 101B generates an LCD control command based on the decision (step S5) and sends the control command to the automatic loader control unit 102 (step S6).

The control command conversion unit 102B of the automatic loader control unit 102 then converts the received LCD control command to an LCD control signal for controlling and driving the LCD (step S7), and sends this LCD control signal to the LCD (step S8). As a result, the display state of the LCD or the content of the displayed message is changed (step S9).

Using the LCD control command that is used to control the display state of the LCD (message display unit) by way of example, the commands and command parameters are described below.

(1) Command A: A Command for Displaying a Specified Text String on the LCD

command A m n d1, d2, . . . dk

where parameter m specifies the position of the first display column, parameter n specifies the position of the first display row, and parameters d1, d2, . . . dk specify the character codes of the text string to be displayed.

(2) Command B: A Command Controlling the Specified Display State

command B m

where parameter m is the value 0, 1, or 2. When m=0, the LCD screen is erased. All text is cleared and the cursor position and cursor type are reinitialized. When m=1, the LCD is driven to display text and the cursor in their current positions. When m=2, the LCD displays nothing.

(3) Command C: A Command Specifying the Cursor Position
command C m n

where parameter m specifies the column and n specifies the row, and the cursor moves to the position denoted by m and n.

(4) Command D: A Command Specifying the Cursor Operation
command D m n

where m and n are parameters, m=0 or 1, n=0 or 1, m specifies the cursor operation, and n specifies the setting as shown in the following table.

TABLE 1

| m | cursor operation | n | setting |
|---|---|---|---|
| 0 | cursor type | 0 | do not display |
| | | 1 | blink |
| | | 2 | display underscore |
| 1 | cursor movement | 0 | move |
| | | 1 | do not move |

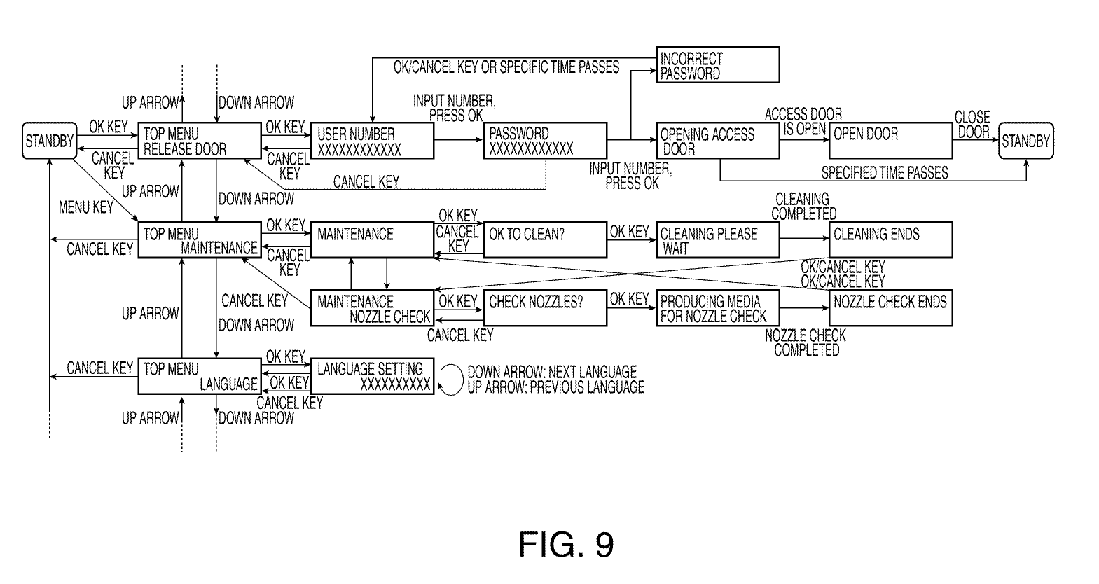

FIG. 9 shows an example of display content for guiding user operations on the LCD (message display unit) of the media processing device according to the first embodiment of the invention. The LCD display control method described above causes the content displayed on the LCD to change as shown in FIG. 9 to provide guidance for user operations.

Referring to FIG. 9, when in the standby mode (the LCD does not display) and the user presses the OK button, an input signal associated with the OK key is sent to the automatic loader control unit 102 as shown in the sequence diagram in FIG. 8, converted to an ASB (automatic status back) signal by the automatic status back transmission unit 102A of the automatic loader control unit 102, and sent to the main control unit 101.

The automatic status back evaluation unit 101A of the main control unit 101 interprets the ASB signal, and based on the result the control command generating unit 101B generates and sends to the automatic loader control unit 102 the following LCD control commands: command B 1; command A 1 1 TOP MENU; command A 1 2 RELEASE DOOR.

When the control command conversion unit 102B of the automatic loader control unit 102 converts these LCD control commands to LCD control signals and sends the control signals to the LCD, TOP MENU RELEASE DOOR is displayed and a menu relating to unlocking the access door 3 is displayed on the LCD.

If the user presses the OK button, the input signal associated with the OK button is sent to the automatic loader control unit 102, and converted to an ASB signal and sent to the main control unit 101 by the automatic status back transmission unit 102A of the automatic loader control unit 102. The automatic status back evaluation unit 101A of the main control unit 101 interprets the ASB signal, and based on the result the control command generating unit 101B generates and sends to the automatic loader control unit 102 the following message display and other LCD control commands: command B 0, command A 1 1 USER NUMBER; command D 0 2, command C 1 2.

When the control command conversion unit 102B of the automatic loader control unit 102 converts these LCD control commands to LCD control signals and sends the control signals to the LCD, “USER NUMBER” is displayed on the first line of the LCD to prompt the user to input the user number. The cursor position (displayed by an underscore character) enabling data input is set to column 1, row 2 for user number input.

The user number is then input at the cursor position. Instead of using a numeric keypad, the digit in the first column of the user number is input using a method such as changing the numbers 0 to 9 each time the up or down arrow key is pressed. Pressing the right arrow key moves the cursor to the second column. The number in the second column is then input in the same way, and the OK key is pressed after all digits in the user number have been sequentially entered. Note, further, that commands A to D are appropriately used to control the LCD as shown in the control sequence in FIG. 8.

The LCD then changes to display “PASSWORD XXXXXXXXXXXX” and present the password input screen. After the entire password has been sequentially input using the same method used to input the user number, the OK key is pressed. If the password is wrong, INCORRECT PASSWORD is displayed on the LCD, the user presses OK or CANCEL, or the user number input screen is redisplayed after waiting a specified time without key input. Note that these actions also use the suitable commands A to D, and the LCD is controlled as shown in the control sequence in FIG. 8.

If the password is correct, the main control unit 101 receives the ASB signal sent from the automatic loader control unit 102 as shown in the control sequence in FIG. 8, and a control command for opening the access door 3 is generated and sent to the automatic loader control unit 102. Receiving this the automatic loader control unit 102 controls the electronic lock locking the access door 3 and causes the access door 3 to be unlocked.

At the same time the automatic status back evaluation unit 101A of the main control unit 101 interprets the ASB signal, and based on the result the control command generating unit 101B generates and sends to the automatic loader control unit 102 the following message display and other LCD control commands: command B 0; command A 1 1 OPENING; command A 1 2 ACCESS DOOR.

When the control command conversion unit 102B of the automatic loader control unit 102 converts these LCD control commands to LCD control signals and sends the control signals to the LCD, OPENING ACCESS DOOR is displayed.

When the user then opens the access door 3, a sensor detects the open door, the automatic status back transmission unit 102A of the automatic loader control unit 102 converts this information to an ASB signal and sends the ASB signal to the main control unit 101. The automatic status back evaluation unit 101A of the main control unit 101 then interprets the ASB signal, and based on the result the control command generating unit 101B generates and sends to the automatic loader control unit 102 the following LCD control commands: command B 0; command A 1 1 ACCESS DOOR; command A 1 2 IS OPEN.

When the control command conversion unit 102B of the automatic loader control unit 102 converts these LCD control commands to LCD control signals and sends the control signals to the LCD, “ACCESS DOOR IS OPEN” is displayed.

When the user then closes the access door 3, a sensor detects the closed door, the automatic status back transmission unit 102A of the automatic loader control unit 102 converts this information to an ASB signal and sends the ASB signal to the main control unit 101. The automatic status back evaluation unit 101A of the main control unit 101 then interprets the ASB signal, and based on the result the control command generating unit 101B generates and sends to the automatic loader control unit 102 the following LCD control command: command B 2.

When the control command conversion unit 102B of the automatic loader control unit 102 converts this LCD control command to an LCD control signal and sends the control signals to the LCD, the LCD screen is cleared of content (reset to the standby mode state).

Note that detailed description of the content of the control commands is omitted below.

Alternatively, when the user presses the MENU key in the standby mode, “TOP MENU MAINTENANCE”, which is the top menu associated with label printer 11 maintenance, is displayed. If the user then presses the OK button, a menu for cleaning the inkjet head 61 is displayed and MAINTENANCE CLEANING is displayed on the LCD.

If the user presses OK again, OK TO CLEAN? is displayed to ask the user whether to continue with head cleaning. If the user presses OK again, the main control unit 101 sends a printer control command to the printer control unit 103 using the same sequence followed when the automatic loader control unit 102 sends a control command, and the printer control unit 103 executes the head cleaning operation by means of the head maintenance mechanism 81 of the label printer 11 upon receiving the command.

CLEANING PLEASE WAIT is then displayed on the LCD following the same LCD display control sequence described above. When head cleaning is completed, CLEANING COMPLETED is displayed. When the user then presses OK or CANCEL, MAINTENANCE CLEANING is displayed again.

If the user presses the down arrow key while MAINTENANCE CLEANING is displayed, CHECK NOZZLES? is displayed to ask the user whether or not to run the nozzle check operation (printing a nozzle check pattern on a blank medium) to check if the ink nozzles of the inkjet head 61 are clogged.

If the user presses the OK key, the label printer 11 prints the nozzle check pattern on a recording medium, and PRODUCING MEDIA FOR NOZZLE CHECK is displayed on the LCD. When printing the nozzle check pattern is completed, NOZZLE CHECK COMPLETED is displayed. When the user then presses OK or CANCEL, MAINTENANCE CLEANING is displayed again.

If the user presses the down arrow key while TOP MENU MAINTENANCE CLEANING is displayed, the display changes to the language configuration menu, TOP MENU LANGUAGE is displayed, and the language displayed on the LCD can be set or changed. If the user presses the OK key, LANGUAGE SETTING XXXXXXXXX is displayed. Note that XXXXXXXXX is replaced by the language name, and the language name can be changed to JAPANESE, ENGLISH, or CHINESE, for example, by pressing the down arrow or up arrow keys.

When the user presses the OK key, the display language is changed or set to the language indicated by XXXXXXXXX, and the LCD changes to present TOP MENU LANGUAGE in the selected language. Note that if the CANCEL key is pressed the display language does not change and TOP MENU LANGUAGE is displayed again.

It should be noted that the top menu can be changed to display other menus by pressing the up arrow or down arrow keys.

The media processing device, the control method for a media processing device, and the control program for a media processing device according to the first embodiment of the invention can guide the steps executed by the user and smoothly change the selected menu or processing mode as a result of the user reading the content that is displayed according to the state change of the media processing device 1 on the LCD (message display unit), which is disposed to the operating panel 5 of the media processing device 1, when the user adds or removes media or performs maintenance, for example.

Furthermore, because the automatic loader control unit 102 and the main control unit 101 are independent of each other, changes to the software specifications of the host computer 200, for example, can be accommodated by simply changing the main control unit 101 (replacing the main control unit 101 or updating the software executed by the main control unit 101).

### Embodiment 2

A media processing device and a control method for a media processing device according to a second embodiment of the invention are described next.

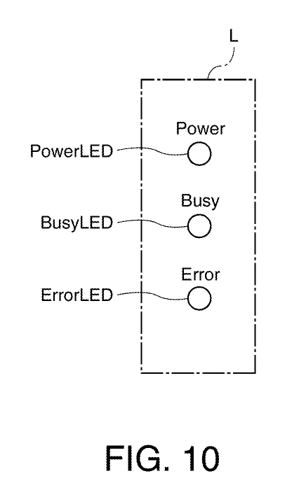

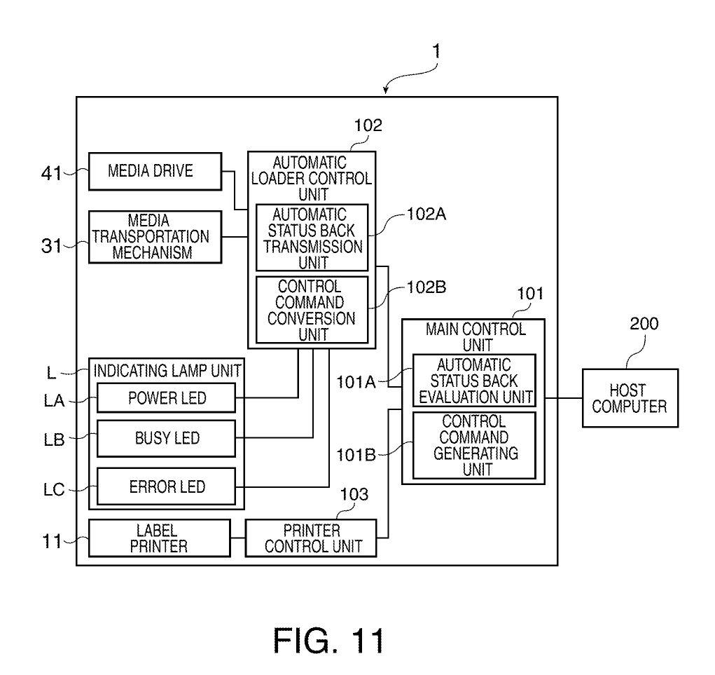

FIG. 10 is an enlarged view of the indicating lamp unit L of the media processing device according to the second embodiment of the invention, and FIG. 11 is a block diagram showing the main parts of the control configuration of the media processing device according to the second embodiment of the invention.

This second embodiment outputs a simultaneous indicating lamp control command, which is a control command for the indicating lamp unit L. As shown in FIG. 10 the indicating lamp unit L has a plurality of LEDs as indicating lamps, and more specifically has a Power LED, Busy LED, and Error LED. As shown in FIG. 11, the indicating lamp unit L is controlled by (the simultaneous indicating lamp control command output from) the automatic loader control unit. Note that the indicating lamp unit L may be disposed to the operating panel 5, or the indicating lamp unit L may be disposed to the media processing device alone without providing an operating panel 5 that has an LCD and input keys.

The simultaneous indicating lamp control command is a command that can simultaneously change the illumination pattern, which is a combination of the on and off states of plural specified LEDs (indicating lamps), and each combination of the on and off states of plural LEDs is given unique meaning. Examples of state changes in the media processing device 1 according to the second embodiment of the invention include starting and stopping operation of the media drives 41, media transportation mechanism 31, label printer 11, and access doors 3 and 4, errors, and warnings.

The simultaneous indicating lamp control command format is described below.

If the simultaneous indicating lamp control command is command A, the syntax of command A is:

command A m1 n1 m2 n2 m3 n3

where m (m1, n1, m2) is a parameter denoting the LED type, m=0 is the Power LED, m=1 is the Busy LED, and m=2 is the Error LED; and n (n2, m3, n3) is a parameter denoting the illumination pattern, n=0 denotes off, n=1 denotes on, n=2 denotes blinking, and n=3 denotes blinking quickly.

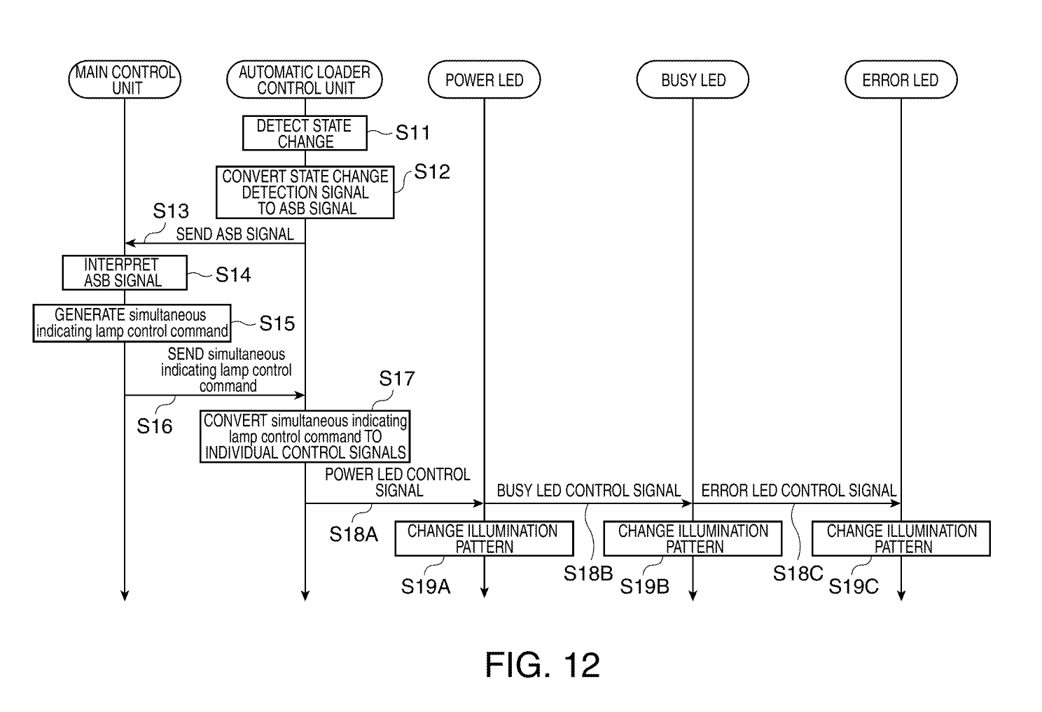

The control method of the indicating lamp unit in a media processing device according to the second embodiment of the invention is described next with reference to FIG. 12 using by way of example a control method for changing the illumination pattern of an indicating lamp unit having three LEDs. FIG. 12 shows the sequence for simultaneously controlling three LEDs by means of the simultaneous indicating lamp control command.

Referring to FIG. 12, when a state change in the media processing device 1 is detected (step S11), the automatic status back transmission unit 102A of the automatic loader control unit 102 converts the detection signal of the detected state change to an ASB signal (step S12) and sends the ASB signal to the main control unit 101 (step S13). Upon receiving this signal the automatic status back evaluation unit 101A of the main control unit 101 interprets the ASB signal (step S14), and based on the result the control command generating unit 101B generates and outputs a simultaneous indicating lamp control command setting a pattern, such as command A 0 2 1 1 2 1, to change the illumination pattern of the three LEDs on the indicating lamp unit L.

The command A 0 2 1 1 2 1 is sent to the automatic loader control unit 102 (step S15). The control command conversion unit 102B of the automatic loader control unit 102 converts this command A 0 2 1 1 2 1 to individual control commands (that is, the Power LED control signal, Busy LED control signal, and Error LED control signal) (step S16).

The automatic loader control unit 102 sends the Power LED control signal to the Power LED (step S17A), changes the illumination pattern (step S18A), sends a Busy LED control signal to the Busy LED (step S17B) and changes the illumination pattern (step S18B), and sends an Error LED control signal to the Error LED (step S17C) and changes the illumination pattern (step S18C). It should be noted that if the illumination pattern of the LEDs before the command A 0 2 1 1 2 1 is sent is Power LED=on, Busy LED=off, and Error LED=off, the illumination pattern of the Power LED is changed from on to blinking. The illumination pattern of the Busy LED is changed from off to on, and the illumination pattern of the Error LED is changed from off to on.

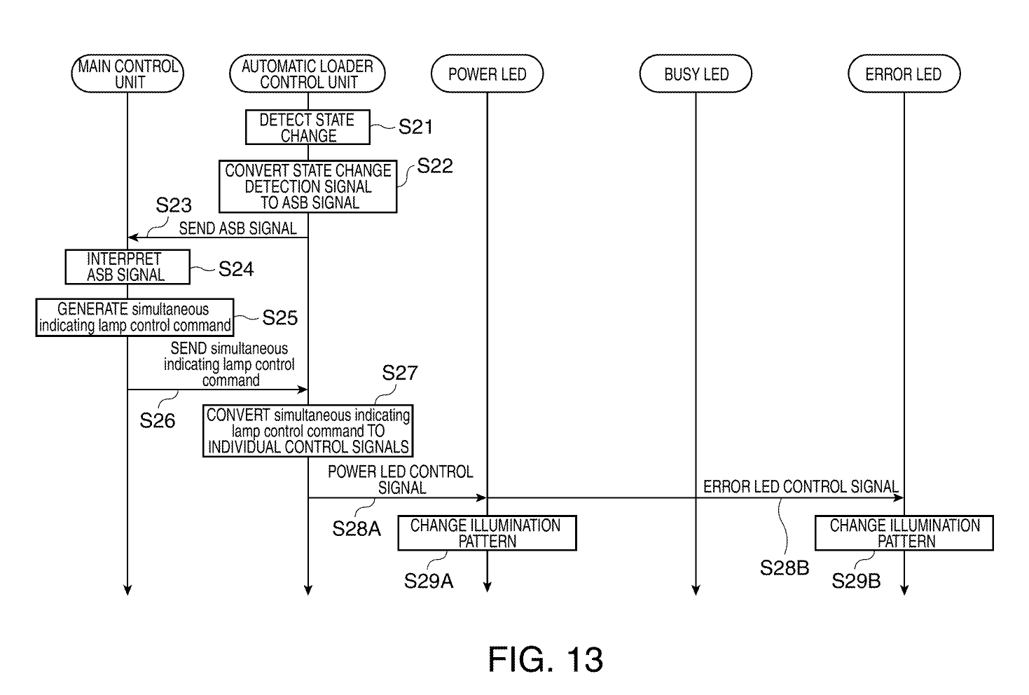

A control method used when changing the illumination pattern of two LEDs in the indicating lamp unit is described next with reference to FIG. 13. FIG. 13 is a sequence diagram of simultaneous control of two LEDs by means of the simultaneous indicating lamp control command.

Referring to FIG. 13, when a state change in the media processing device 1 is detected (step S21), the automatic status back transmission unit 102A of the automatic loader control unit 102 converts the detection signal of the detected state change to an ASB signal (step S22) and sends the ASB signal to the main control unit 101 (step S23). Upon receiving this ASB signal the automatic status back evaluation unit 101A of the main control unit 101 interprets the ASB signal (step S24), and based on the result the control command generating unit 101B generates and outputs a simultaneous indicating lamp control command, such as command A 0 2 2 2, setting a pattern to change the illumination pattern of two LEDs on the indicating lamp unit L.

The command A 0 2 2 2 is sent to the automatic loader control unit 102 (step S25). The control command conversion unit 102B of the automatic loader control unit 102 converts this command A 0 2 2 2 to individual control commands (that is, the Power LED control signal and Error LED control signal) (step S26).

The automatic loader control unit 102 sends the Power LED control signal to the Power LED (step S27A) and changes the illumination pattern thereof (step S28A), and sends an Error LED control signal to the Error LED (step S27B) and changes the illumination pattern thereof (step S28B).

It should be noted that if the illumination pattern of the LEDs before the command A 0 2 2 2 is sent is Power LED=on and Error LED=off, the illumination pattern of the Power LED is changed from on to blinking. The illumination pattern of the Error LED is changed from off to blinking. The display state of the Busy LED, which is not addressed by the command, does not change.

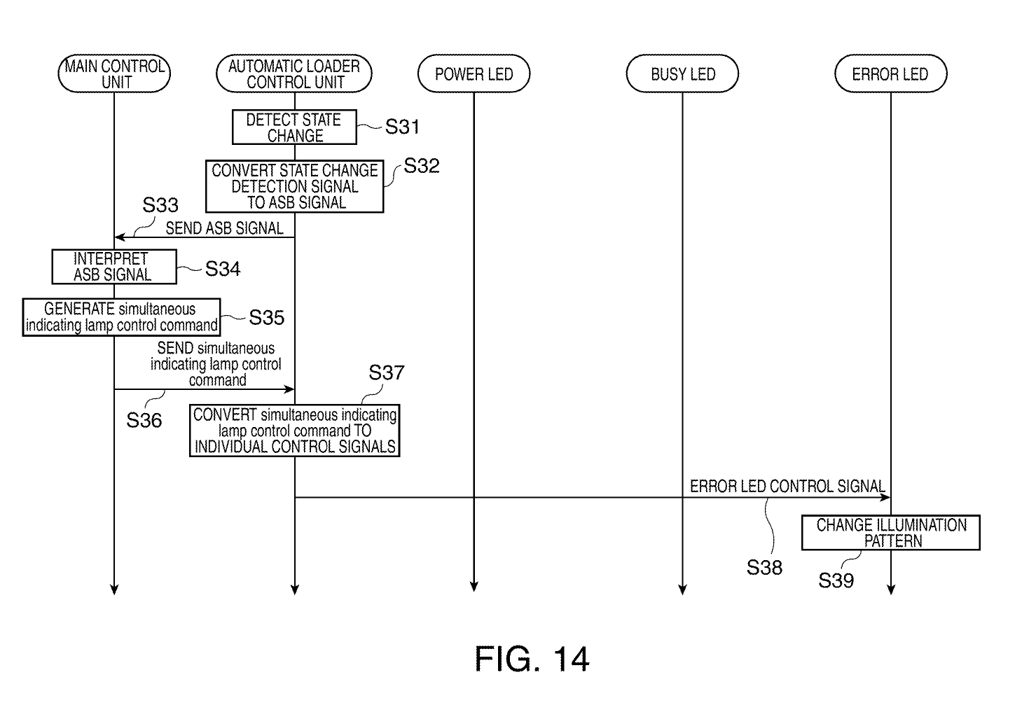

A control method used when changing the illumination pattern of one LED in the indicating lamp unit is described next with reference to FIG. 14. FIG. 14 is a sequence diagram of simultaneous control of one LED by means of the simultaneous indicating lamp control command.

Referring to FIG. 14, when a state change in the media processing device 1 is detected (step S31), the automatic status back transmission unit 102A of the automatic loader control unit 102 converts the detection signal of the detected state change to an ASB signal (step S32) and sends the ASB signal to the main control unit 101 (step S33). Upon receiving this ASB signal the automatic status back evaluation unit 101A of the main control unit 101 interprets the ASB signal (step S34), and based on the result the control command generating unit 101B generates and outputs a simultaneous indicating lamp control command, such as command A 2 1, setting a pattern to change the illumination pattern of one LED on the indicating lamp unit L.

The command A 2 1 is sent to the automatic loader control unit 102 (step S35). The control command conversion unit 102B of the automatic loader control unit 102 converts this command A 2 1 to an Error LED control signal (step S36).

The automatic loader control unit 102 sends the Error LED control signal to the Error LED (step S37) and changes the illumination pattern thereof (step S38).

It should be noted that if the illumination pattern of the Error LED before the command A 2 1 is sent is off, the illumination pattern of the Error LED is changed from off to on.

The media processing device, control method for a media processing device, and control program for the same according to the second embodiment of the invention can eliminate or reduce deviations in the timing at which the illumination pattern of the individual LEDs (indicating lamps) changes when unique meaning is given to the illumination patterns of different combinations of plural LEDs (indicating lamps) because the illumination pattern of the plural LEDs (indicating lamps) can be changed by a single simultaneous indicating lamp control command. The invention also facilitates synchronizing the timing at which the LEDs (indicating lamps) blink when a plurality of LEDs (indicating lamps) are made to blink simultaneously.

Furthermore, because the automatic loader control unit 102 and the main control unit 101 are independent of each other, changes to the software specifications of the host computer 200, for example, can be accommodated by simply changing the main control unit 101 (replacing the main control unit 101 or updating the software executed by the main control unit 101).

### Embodiment 3

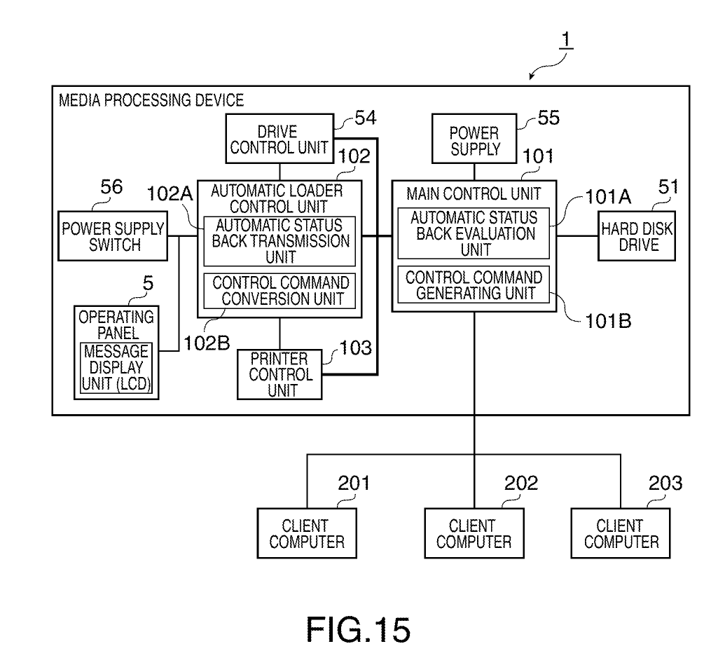

A third embodiment of the invention is described next. FIG. 15 is a block diagram describing the internal processes of the media processing device according to the third embodiment of the invention.

In this third embodiment of the invention the state change detected in the media processing device 1 is when the power supply switch turns off while the media processing device 1 is operating, in which case the automatic loader control unit 102 detects the power supply switch turning off as the state change, converts this to an automatic status back (ASB) signal, and sends the ASB signal to the main control unit 101.

The media processing device 1 according to the third embodiment of the invention is communicably connected through a LAN or other network to a plurality of client computers 201, 202, 203, and executes media production processes based on media production jobs sent from any of the client computers 201, 202, 203. The media processing device 1 is shared by a plurality of client computers 201, 202, 203, and can process media production jobs created by a plurality of users.

As shown in FIG. 15 the main parts of the media processing device 1 include a main control unit 101, a hard disk drive 51, the automatic loader control unit 102, the printer control unit 103, a drive control unit 54, a power supply 55, a power supply switch 56, and a message display unit (LCD) disposed to the operating panel 5.

The main control unit 101 manages media production jobs sent from the client computers 201, 202, 203. The main control unit 101 manages execution and completion of plural media production jobs, and reports the media production job execution and completion status to the respective client computer. The main control unit 101 manages jobs by, for example, starting a media production job from client computer 202 after a media production job for client computer 201 is completed normally.

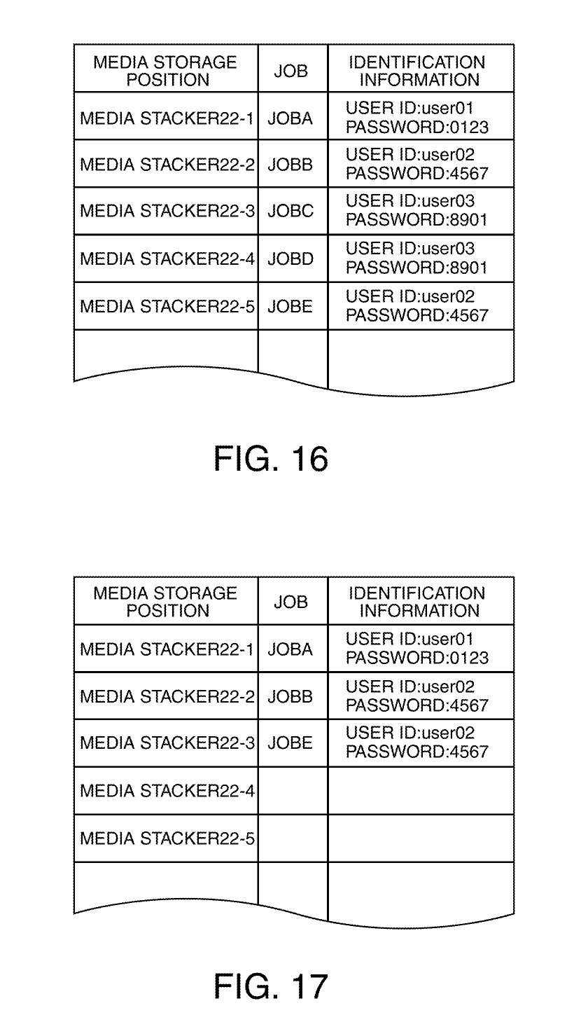

The main control unit 101 also manages where each completed disc M is stored in which stacker by means of a job management table stored in the hard disk drive 51. For example, in the security mode described above, media storage in media stacker 22 is managed using a job management table such as shown in FIG. 16.

For example, when media production job A created by a user (user ID=user01, password=0123) of client computer 201 is received, the main control unit 101 sends appropriate commands to the other processing units to execute job A. When job A is completed, the job management table for the media M is updated. More specifically, the job management table is updated to show that the completed disc M for job A is stored on the first layer of media stacker 22 (denoted media stacker storage position 22-1). Each time a media production job is completed, the disc storage position and corresponding user identification information are saved in the job management table. FIG. 16 shows an example in which completed discs M are stored in layer 1 to layer 5 in media stacker 22.

When a completed disc M stored in media stacker 22 is then removed, a media discharge job is created and executed to retrieve and discharge the completed media M matching the identification information in accordance with the input user identification information. For example, if the user ID “user03” and the password “8901” are input as the identification information, a media discharge job is created and executed to move the completed discs M stored at layer 3 and layer 4 of the media stacker 22 into media stacker unit 71.

More specifically, the completed disc M for job E that is stacked on top of the completed media M for job C and job D that are to be removed is temporarily moved to media stacker 21, and only the completed discs M for job C and job D are moved to the media stacker unit 71. The completed disc M that was moved temporarily to the media stacker 21 is then returned to the original media stacker 22. This sequence of media transportation operations is created and executed as a media discharge job.

When the discharge job ends, the media stacker storage positions 22-3, 22-4, 22-5 are updated as shown in FIG. 17. As a result, the completed medium for job E is known to be stored at media stacker storage position 22-3, and media stacker storage positions 22-4 and 22-5 are empty.

The power supply 55 of the media processing device 1 is connected to the main control unit 101, which controls turning the power supply 55 on and off. For example, when an ASB signal denoting the power supply switch is off is received from the automatic loader control unit 102, the automatic status back evaluation unit 101A interprets the received ASB signal. If the automatic status back evaluation unit 101A determines as a result that the power supply switch is off, the main control unit 101 determines if the completed medium M is stored in the media processing device by referring to the job management table described above. If it is determined that the completed medium M has not been stored, the main control unit 101 controls executing a process to turn the power supply 55 off.

If the main control unit 101 receives a power switch off ASB signal from the automatic loader control unit 102 while executing the completed media M transportation process, the main control unit 101 controls processing so that operation waits until the entire transportation process of moving the completed media M to be discharged to the media stacker unit 71 ends, and then executes the process of turning the power supply 55 off after the transportation process ends.

In addition, if a power switch off automatic status back (ASB) report is received from the automatic loader control unit 102 while receiving data from one of the client computers 201, 202, 203, processing is controlled to wait until data reception ends and then turn the power off after reception ends.

Yet further, if a power switch off ASB signal is received from the automatic loader control unit 102 while the printer control unit 103 is executing a printing process by means of the label printer 11 or the drive control unit 54 is executing a data writing process by means of a media drive 41, the main control unit 101 controls operation so that processing waits until the printing process or the data writing process ends, and then executes the process of turning the power off after any executing processes end. Note that these processes may also include media transportation processes.

The automatic loader control unit 102 controls the transportation process of the media transportation mechanism 31 according to each job. A power supply switch 56 for turning the power supply 55 of the media processing device 1 on and off is connected to the automatic loader control unit 102. When a signal turning the power supply switch 56 off is input, the automatic status back transmission unit 102A of the automatic loader control unit 102 converts the detection signal of the detected state change, that is, that the power supply switch 56 turned off, to an ASB signal, and sends the power switch off ASB signal to the main control unit 101.

The printer control unit 103 controls the printing processes of the label printer 11 according to each media production job to print a label on the label side of the CD, DVD, or other medium M.

The drive control unit 54 also controls the data writing processes of the media drives 41 based on each media production job to write data to the data recording side of the medium M.

The message display unit (LCD) disposed to the operating panel 5 displays the status of the media processing device 1. An off signal is input by the power supply switch 56 in the third embodiment, but an appropriate message is displayed if the power off operation could not actually be executed.

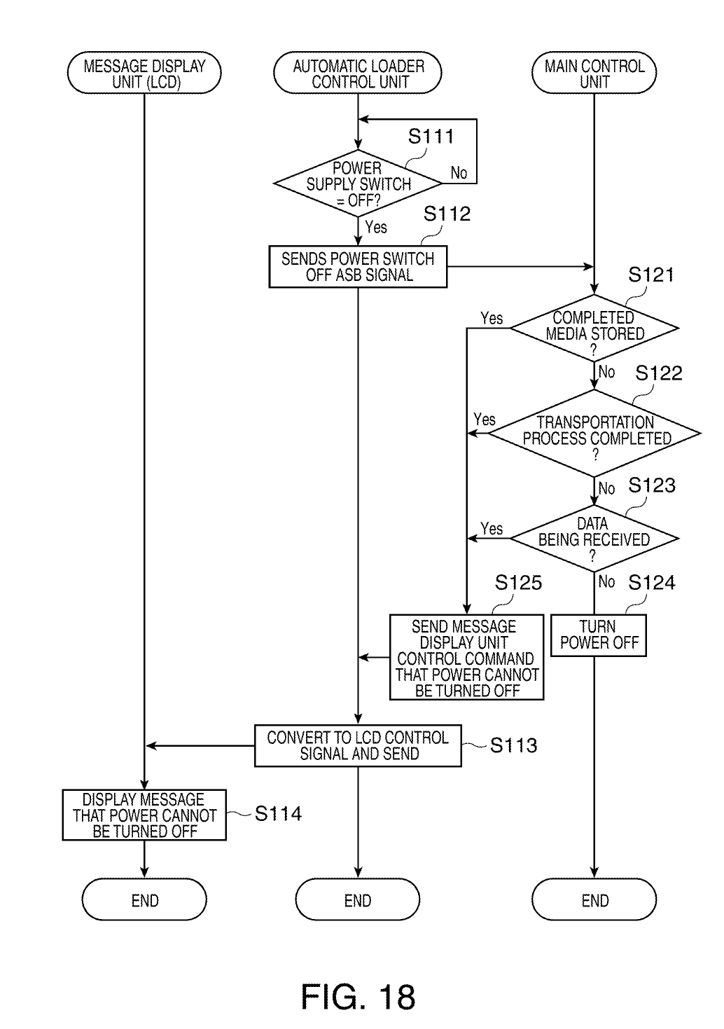

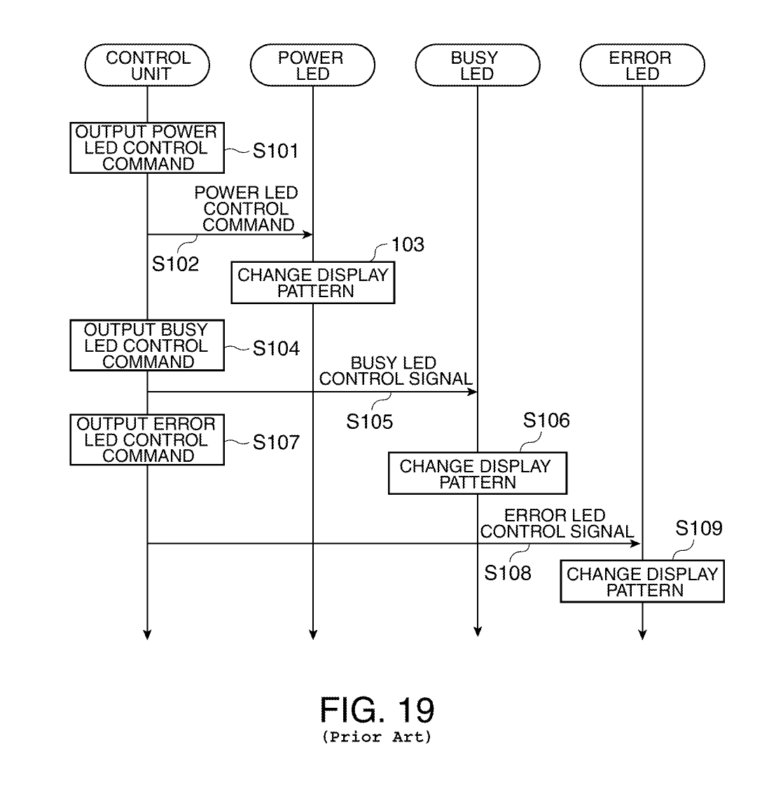

The control method of the media processing device described above is described next. FIG. 18 is a flow chart describing the control method of this third embodiment.

The control method of the third embodiment is configured so that the power off process is not executed immediately when the off signal from the power supply switch 56 is input if completed media M remains in the media processing device 1. More specifically, by keeping the power supply on and keeping the security system enabled as long as there is a possibility that completed media M to which information assets have been written remain inside, persons other than an authorized media producer can be prevented from acquiring the completed media.

How the on/off process of the power supply 55 is controlled to maintain the security system is described below.

When the automatic loader control unit 102 detects input of an off signal (a state change) from the power supply switch 56 to turn the power supply 55 off (step S111 returns Yes), the automatic loader control unit 102 sends a power switch off ASB signal denoting that the power supply switch 56 was pressed to the main control unit 101 (step S121).

When the power switch off ASB signal is received, the main control unit 101 checks whether or not completed media M is stored in the media stackers 21 and 22, media stacker unit 71, or the (separate) media stacker 72. Whether or not completed media M is stored can be determined by referring to the job management table for each stacker.

If it is determined that completed media M are stored (step S121 returns Yes), the control command generating unit 101B generates and sends to the automatic loader control unit 102 a message display unit control command indicating that the power supply 55 cannot be turned off (step S125). The control command conversion unit 102B of the automatic loader control unit 102 converts the message display unit control command indicating that the power supply 55 cannot be turned off to an LCD control signal, and sends the LCD control signal to the message display unit (LCD) (step S113). A message indicating that the power supply 55 cannot be turned off because completed media M remain inside is then displayed on the message display unit (LCD) disposed to the operating panel 5 as a result of this LCD control signal (step S114).

If the main control unit 101 determines that completed media M are not stored (step S121 returns No) as a result of referencing the job management table for each stacker, it determines if the media transportation process is being executed. More specifically, if the media discharge job described above is being executed (step S122 returns Yes), the control command generating unit 101B generates and sends to the automatic loader control unit 102 a message display unit control command indicating that the power supply 55 cannot be turned off (step S125), and then turns the power off after waiting for the discharge job to end.

However, if a media discharge job is not executing (step S122 returns No), whether or not data is being received from a client computer 201, 202, 203 is determined. If data is being received, the control command generating unit 101B generates and sends to the automatic loader control unit 102 a message display unit control command indicating that the power supply 55 cannot be turned off (step S125), and then turns the power off after waiting for data reception to end.

If data is not being received (step S123 returns No), the main control unit 101 executes the process turning the power supply 55 off (step S124).

It should be noted that how long the power supply 55 is pressed (the “depression time”) may be detected in step S111, and a depression time ASB signal may be sent together with the power switch off signal. The process turning the power supply 55 off may also be configured according to how long the power supply switch 56 is depressed. For example, the process may be configured to unconditionally turn the power supply 55 off regardless of what other process may be executing when an ASB signal indicating the switch was depressed for 3 seconds or more is sent to the main control unit 101.

When thus configured the depression time and detection method settings can be easily changed because the power supply switch 56 is connected to the automatic loader control unit 102.

As described above the power supply switch 56 is connected to the automatic loader control unit 102 and the power supply 55 is connected to the main control unit 101 in the third embodiment of the invention. More specifically, because the power supply switch 56 and power supply 55 are connected to separate control units, the power supply does not turn off immediately when a signal turning the power supply switch 56 off is input.

In addition, the main control unit 101 to which the power supply is connected turns the power supply 55 off when it is determined that completed media M are not stored. More specifically, the power supply 55 does not turn off when completed media M are stored inside the media processing device. Because a security system that, for example, disengages a lock after identification and authentication using an ID and password is kept enabled, persons other than the authorized media producer can be prevented from acquiring the completed media.

Furthermore, in this third embodiment of the invention the power supply 55 does not turn off until the entire transportation process that discharges the completed media M selected for discharge ends. When only the completed media M for job C and job D are selected for discharge from a media stacker 22 storing five completed media M in a stack as shown in FIG. 17, a series of transportation operations must be executed in order to first move the completed media M for job E stacked on top of the completed media M to be discharged one by one to another media stacker 21 by means of media transportation mechanism 31, discharge only the completed media M for job C and job D to the media stacker unit 71, and then return the completed media M for job E that were previously moved aside to the original media stacker 22.

Yet further, because the power supply 55 does not turn off while completed media M are being transported in this third embodiment of the invention, the stacking order of the completed media M is prevented from changing, and discharging completed media M to the authorized user can be assured.

Yet further, because the power supply 55 does not turn off until data reception ends in this third embodiment of the invention if a power switch off ASB signal is received from the automatic loader control unit 102 while receiving data from a client computer 201, 202, 203, interruption of the data being received can be prevented and information assets can be protected.

Yet further, because the main control unit 101 handles job management in this third embodiment of the invention, whether or not completed media M is stored can be determined by simply referencing the job management table. A separate detection mechanism for detecting if completed media M are present is therefore not necessary, and a detection process is not necessary.

Although embodiments of the present invention have been illustrated and described, various changes and modifications will be apparent to those skilled in the art in light of this disclosure. Any such change or modification is intended to be included in the scope of the present invention at least to the extent such change or modification falls within any of the appended claims.

What is claimed is:

1. A control method for operating a media processing device having a printer that prints on a label side of media, a media storage unit that stores the media, a media transportation mechanism that transports the media, a loader control unit that controls the printer and the media transportation mechanism, and a main control unit that sends control commands to and controls the loader control unit, the control method comprising:
sending, from the loader control unit, information relating to a state change to the main control unit based on a state change in at least one of the printer or the media transportation mechanism; and
evaluating the received information related to the state change and executing a process based on the result of the evaluation, the evaluating and executing operations being performed by the main control unit.

2. The control method for operating a media processing device described in claim 1, wherein the media processing device has an operating panel including an input unit and a display unit that displays a message, the loader control unit controlling the display unit; and wherein the executing operation is a process of generating and sending to the loader control unit a display unit control command including the message, the control method further comprising:
controlling the display unit and displaying the message according to the received display unit control command, the controlling and displaying operations being carried out by the loader control unit.

3. The control method for operating a media processing device described in claim 2, wherein, in the sending step, the loader control unit sends information related to the state change to the main control unit when an input signal is received from the input unit.

4. The control method for operating a media processing device described in claim 2, wherein, in the sending step, the loader control unit sends information related to the detected state change to the main control unit when a state change sensed by a sensor disposed to the media processing device is detected.

5. The control method for operating a media processing device described in claim 1, wherein the media processing device has a lamp unit including a plurality of lamps and the loader control unit controls the lamp unit, and wherein the executing operation is a process of generating and sending to the loader control unit a simultaneous lamp control command that simultaneously controls the plurality of lamps, the control method further comprising:
receiving, by the loader control unit, the simultaneous lamp control command sent from the main control unit, simultaneously controlling the plurality of lamps specified by the simultaneous lamp control command, and simultaneously changing the illumination pattern of the lamps.

6. The control method for operating a media processing device described in claim 1, wherein the media processing device has a power supply, and a power supply switch, for the power supply, connected to the loader control unit, the state change is a change in the input state of the power supply switch, and the state change evaluation determines whether or not power supply switch input is off, and the process based on the result of the evaluation is a process of determining if a specified process is executing when the evaluation result is that the power supply switch is off, the control method further comprising:
executing a process of turning the power supply off at least when it is determined that the specified process is not executing.

7. The control method for operating a media processing device described in claim 6, wherein the media processing device has a discharge unit to which the media are discharged, and the specified process is a process of transporting the media by the media transportation mechanism to the discharge unit, and wherein:
the process of turning the power supply off is executed after the media transportation process ends, when it is determined that the media transportation process is executing.

8. The control method for operating a media processing device described in claim 6, wherein the media processing device is connectable to a computer, and the specified process is receiving data from the computer, and wherein:
the process of turning the power supply off is executed after the data reception process ends, when it is determined that data is being received from the computer.

9. A tangible medium readable by a media processing device, the tangible medium containing a control program for causing the loader control unit and the main control unit to execute the steps of the control method described in claim 1.

10. A media processing device, comprising:
a printer that prints on the label side of media;
a media storage unit that stores the media;
a media transportation mechanism that transports the media;
a loader control unit that controls the printer and the media transportation mechanism; and
a main control unit that sends control commands to and controls the loader control unit;
the loader control unit including an automatic status back transmission unit that sends to the main control unit information relating to a state change in at least the printer or the media transportation mechanism; and
the main control unit including an automatic status back evaluation unit that evaluates the received information related to the state change and executes a process based on the result of the evaluation.

11. The media processing device described in claim 10, further comprising an operating panel including a display unit that displays a message and an input unit; and wherein:
the loader control unit controls the display unit;
the main control unit has a control command generating unit that generates and sends to the loader control unit a display unit control command including a message based on the result of the evaluation by the automatic status back evaluation unit; and
the loader control unit has a control command conversion unit for displaying the message on the display unit based on the received display unit control command.

12. The media processing device described in claim 10, comprising a lamp unit having a plurality of lamps; and wherein:
the loader control unit controls the lamp unit;
the main control unit has a control command generating unit that generates and sends to the loader control unit a simultaneous lamp control command that simultaneously changes the illumination pattern of at least two of the lamps specified from among the plurality of lamps; and
the loader control unit has a control command conversion unit that converts the received simultaneous lamp control command to a control signal that simultaneously changes the illumination pattern of the specified lamps.

13. The media processing device described in claim 10, comprising a power supply, and a power supply switch, for controlling the power supply, connected to the loader control unit; and wherein:
the state change is a change in the input state of the power supply switch;
the state change evaluation determines whether or not power supply switch input is off;
the process based on the result of the evaluation is a process of determining if a specified process is executing when the evaluation result is that the power supply switch is off; and
the main control unit executes a process turning the power supply off at least when it is determined that the specified process is not executing.

14. The media processing device described in claim 13, wherein the main control unit executes a process of turning the power supply off after the specified process ends, if the evaluation result is that the power supply is off and the specified process is executing at that time.

15. The media processing device described in claim 14, further comprising a discharge unit to which the media are discharged; wherein:
the specified process is a media transportation process of the media transportation mechanism; and
the main control unit executes the process of turning the power supply off after the media transportation process ends.

16. The media processing device described in claim 14, wherein:
the media processing device is connectable to a computer;
the specified process is receiving data from the computer; and
the main control unit executes the process of turning the power supply off after the data reception process ends.

17. The media processing device described in claim 13, comprising:
a cover; and
an electronic lock for locking and unlocking the cover;
wherein the main control unit controls the electronic lock.
